(19) United States
(12) Patent Application Publication
(10) Pub. No.: US 2014/0019535 A1
(43) Pub. Date: Jan. 16, 2014

(54) SOCIAL GROUP-BASED WISH LISTS

(71) Applicants: Scott M. Guminy, Newmarket (CA); Leho Nigul, Richmond Hill (CA)

(72) Inventors: Scott M. Guminy, Newmarket (CA); Leho Nigul, Richmond Hill (CA)

(73) Assignee: INTERNATIONAL BUSINESS MACHINES CORPORATION, Armonk, NY (US)

(21) Appl. No.: 13/546,658

(22) Filed: Jul. 11, 2012

(51) Int. Cl. G06F 15/16

(52) U.S. Cl. 709/204

(57) ABSTRACT

A social networking group definition that identifies each social group of a social network user within a social networking service is obtained by a processor for each different social networking service used by the user. An associated subset of items of a wish list of the user is identified for at least one identified social group of the obtained social networking group definitions using the social networking group definition. A partition of the wish list, including the identified subset of items of the wish list and the associated identified social group of the user, is defined for each identified subset of items of the wish list. Each partition of the wish list is accessible only by social connections of the user defined by the respective social group within the social networking group definition.

### BACKGROUND

The present invention relates to wish lists. More particularly, the present invention relates to social group-based wish lists.

Social networks allow users to interact with friends within social groups to share photographs, discussions, and other information. Social networking servers and websites hosted by those servers allow users to interact within their social groups.

### BRIEF SUMMARY

A method includes obtaining, via a processor for each different social networking service used by a social network user, a social networking group definition that identifies each social group of the user within the social networking service; identifying, for at least one identified social group of the obtained social networking group definitions, an associated subset of items of a wish list of the user using the social networking group definition; and defining, for each identified subset of items of the wish list, a partition of the wish list comprising the identified subset of items of the wish list and the associated identified social group of the user, where each partition of the wish list is accessible only by social connections of the user defined by the respective social group within the social networking group definition.

A system includes a memory that stores a wish list and a processor programmed to: obtain, for each different social networking service used by a social network user, a social networking group definition that identifies each social group of the user within the social networking service; identify, for at least one identified social group of the obtained social networking group definitions, an associated subset of items of the wish list of the user using the social networking group definition; and define, for each identified subset of items of the wish list, a partition of the wish list comprising the identified subset of items of the wish list and the associated identified social group of the user, where each partition of the wish list is accessible only by social connections of the user defined by the respective social group within the social networking group definition.

A computer program product includes a computer readable storage medium including computer readable program code, where the computer readable program code when executed on a computer causes the computer to obtain, for each different social networking service used by a social network user, a social networking group definition that identifies each social group of the user within the social networking service; identify, for at least one identified social group of the obtained social networking group definitions, an associated subset of items of a wish list of the user using the social networking group definition; and define, for each identified subset of items of the wish list, a partition of the wish list comprising the identified subset of items of the wish list and the associated identified social group of the user, where each partition of the wish list is accessible only by social connections of the user defined by the respective social group within the social networking group definition.

### BRIEF DESCRIPTION OF THE SEVERAL VIEWS OF THE DRAWINGS

FIG. 1 is a block diagram of an example of an implementation of a system for automated social group-based wish lists according to an embodiment of the present subject matter;

FIG. 2 is a block diagram of an example of an implementation of a core processing module capable of performing automated social group-based wish lists according to an embodiment of the present subject matter;

FIG. 3 is a flow chart of an example of an implementation of a process for automated social group-based wish lists according to an embodiment of the present subject matter;

FIG. 4 is a flow chart of an example of an implementation of a process for automated partitioning of social group-based wish lists according to an embodiment of the present subject matter; and

FIG. 5 is a flow chart of an example of an implementation of a process for automated access controls processing of social group-based wish lists according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides social group-based wish lists. Wish lists of social networking users may be partitioned (e.g., segregated/segmented) based upon social network profiles and/or social networking group definitions of the social networking websites/services with which social networking users are social group members. Access controls for wish list items may be connected to social networking website social group definitions, and segmentation information (e.g., metadata) regarding social network segmentation/groups may be utilized to programmatically define wish list partitions utilizing context associated with the respective groups and wish list items. Wish list partition information (e.g., metadata) may be associated with individual wish list items or wish list items may be associated with wish list partition information, as appropriate for a given implementation. Social network definitions may be aggregated, concatenated, and filtered using the social network segmentation information configured from social network profiles to allow the social networking user to customize wish list partitions for access by individual social connections across one or more social networks/groups. As such, the present technology provides partitioned and relevant wish list item suggestions to persons within different social groups to enhance, for example, the gift giving experience for both the social networking user and for the social connections of the user within their respective social networking groups.

The present technology utilizes application programming interface (API) technology and API calls to social networking applications/servers to identify different social groups that a person, termed herein alternatively as an eCommerce user, belongs to and to identify which other people are in those particular social groups. The user may then choose whether to segment existing or new wish lists in accordance with one or more identified social groups. The segmentation of the social groups provides social network segmentation information that may be utilized to regulate distribution of and/or access to the segmented wish list.

Further, the segmentation information may be assigned on a person-by-person basis as metadata within the wish list to define partitions of subsets of items within the wish list. As such, a social network user may utilize existing social group definitions associated with social networking services or create sub-groups within a particular social network using the segmentation metadata for segmented wish list definition and access. Each partition of the wish list may be accessed only by the social connections defined by the respective social group within the respective social network.

Additionally, the segmentation information may be assigned on a person-by-person basis as metadata across social networks to define new custom social groups, and as such, new partitions of subsets of items within a wish list. A social network user may create sub-groups that span multiple social networks using the segmentation metadata for segmented wish list definition and access. Portions of social network definitions may be aggregated, concatenated, and filtered to create sub-groups that do not exist within the social network definitions themselves. Again, each partition of the wish list may be accessed only by the social connections defined by the respective custom social group.

Further, a user may define wish list partitioning rules to identify one or more social connections for formation of customized wish list partitions. For example, a wish list partitioning rule may include creating a partition of a wish list based upon social connections that have indicated that they “like” (via a social networking service) one or more particular items that are also on a user's wish list. The particular social connection would not need to be aware of the wish list or the items on the wish list in such an example. As such, a user may define wish list partitioning rules that utilize individual actions on social networking websites that are associated with items on wish lists to create customized wish list partitions. Further, as another example, a wish list partition rule may be formulated that specifies that wish list items are to be partitioned and displayed only to users that belong to two or more different social networking groups simultaneously. This type of wish list partitioning rule may allow further refinement to wish list partition creation and processing. It should be understood that many other examples of wish list partitioning rule formation based upon individual actions performed via social networking services are possible and all are considered within the scope of the present subject matter.

Once the social network segmentation information/metadata is available, it may be utilized in a variety of different ways. Granularity controls may also be utilized to further enhance distribution of and/or access to the segmented wish list. For example, some items may be designated as “visible to all” and some other items may be configured to be only visible to specific segmented groups within a user's social network. Alternatively, a user may trigger a mass e-mail or mass posting on the segmented social media network about the items in his/her wish list based upon the segmented wish list granularity controls/configuration.

In another example, login information for websites other than social network websites may be correlated with social network segmentation information and segmented/partitioned wish lists. As such, where a friend of the segmented wish list user utilizes the same/similar identifying/registration information (e.g., the same email address) for both the social network segmentation information and a third-party system, such as an online retailer (e.g., eRetailer) for example, the segmented wish list may be utilized during friend accesses to the third-party system. Within this example, in response to the friend logging into the online retailer (e.g., eRetailer) website and choosing to see the wish list of the user, tailored information may be displayed to the friend. The user may alternatively configure multiple emails for social network friends to expand the flexibility of friend identification during website accesses other than the social network website used for the social network.

The present technology utilizes a “master data” approach. The master data approach also allows automated propagation of social network decisions to segmented wish list access controls. As such, if the user changes a social group segmentation definition for a social networking website, all of the changes may be automatically propagated from the social media software service to other websites, such as online retailer websites within the example above. For example, if a person is “de-friended” by a user on a particular social network, any segmented wish list for which this person was configured to be able to access may be modified automatically to prevent this person from accessing the segmented wish list(s). It is understood that for wish list partitions that rely upon social networking group information, the access may be regulated by the group definition and that de-friending the person may automatically prevent this person from accessing the segmented wish list(s) without further modification of wish list partition information. Accordingly, the present technology provides a single point of control of what people in a social network user's social life see with respect to segmented wish lists.

The present subject matter also allows online retailers to work with multiple social media service providers to give the consumers/users greater flexibility in defining custom segmented wish lists for different users in different social networks. For example, a user may choose some items to be visible only to friends of a first social network and some items to be visible only to the connections of a second social network. The user may also give access to friends on multiple social networks, and may also explicitly not give access to (e.g., exclude) individual members of one or more social networking groups. Further, as described above, a wish list partition rule may be formulated that specifies that wish list items are to be partitioned and displayed only to users that belong to two or more different social networking groups simultaneously. This type of wish list partition rule may allow further refinement to wish list partition creation and processing.

A graphical user interface (GUI) component may be utilized to facilitate real-time configuration for a user. For example, a user may be provided with a button or other control that allows the user to publish (e.g., “share) a segmented wish list to one or more social network accounts, one or more segmented social networks, or other access control granularity as appropriate for a given implementation. As such, sharing a segmented wish list may also programmatically place the correct access control(s) on the shared content within the social networking system/server so that the access controls of the social networking system/server match what the user configured within the segmented wish list. Within such an implementation, the social networking system/server may filter the wish list access rights of social network friends to implement the access controls.

As an additional alternative, wish list items may be “pushed” to a social networking system/server from an online retailer's website or “pulled” from the online retailer's website by the social networking system/server for viewing by friends of the segmented wish list user. Within such an implementation, a friend that is logged into the social networking system/server may view wish list items directly on that system rather than traversing a hypertext link to the online retailer's website/system. Further, such processing may be performed transparently to the friends that are accessing the social networking system/server.

It should be noted that conception of the present subject matter resulted from recognition of certain limitations associated with “wish list” operation in association with social networks and social groups. For example, it was observed that one of the primary purposes of the wish list is to allow a person to mark/designate a desired item and to share information related to the marked item (e.g., purchase location or link, cost, etc.) with other people/friends so that these people may consider purchasing the items for the person. However, it was also observed that previous implementations of wish lists consolidate all wish list items into one wish list and publish this one wish list for access by all groups associated with a person. It was further determined that a person may want to align interests with wish lists along lines of social circles. As such, it was determined that these previous implementations of wish lists miss an important aspect of social circuit segmentation where a person may belong to multiple social circuits/networks, but where these social circuits/networks may not overlap. Social circuit/group segmentation was observed to exist among groups of people, such as for example, family groups, work-related groups, and hobby groups. It was also determined that a person may not want to share wish list items related to parenting advice, for example, with his/her hobby friends. It was further determined that, depending on the particular social group/situation, a person may want to compartmentalize wish list selections according to the social group (e.g., social circuit segmentation) to indicate different desired items for visibility and potential purchase by different groups of persons via a wish list. It was also determined that because previous implementations of wish lists consolidate all of these items into one wish list, such granularity and wish-list item publication controls do not exist within previous implementations of wish lists. The present subject matter improves wish list functionality by providing for social group-based wish lists, as described above and in more detail below. As such, improved wish list user controls and processing may be obtained through use of the social group-based wish lists described herein.

The social group-based wish lists described herein may be performed in real time to allow prompt processing of granularly compartmentalized wish lists. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

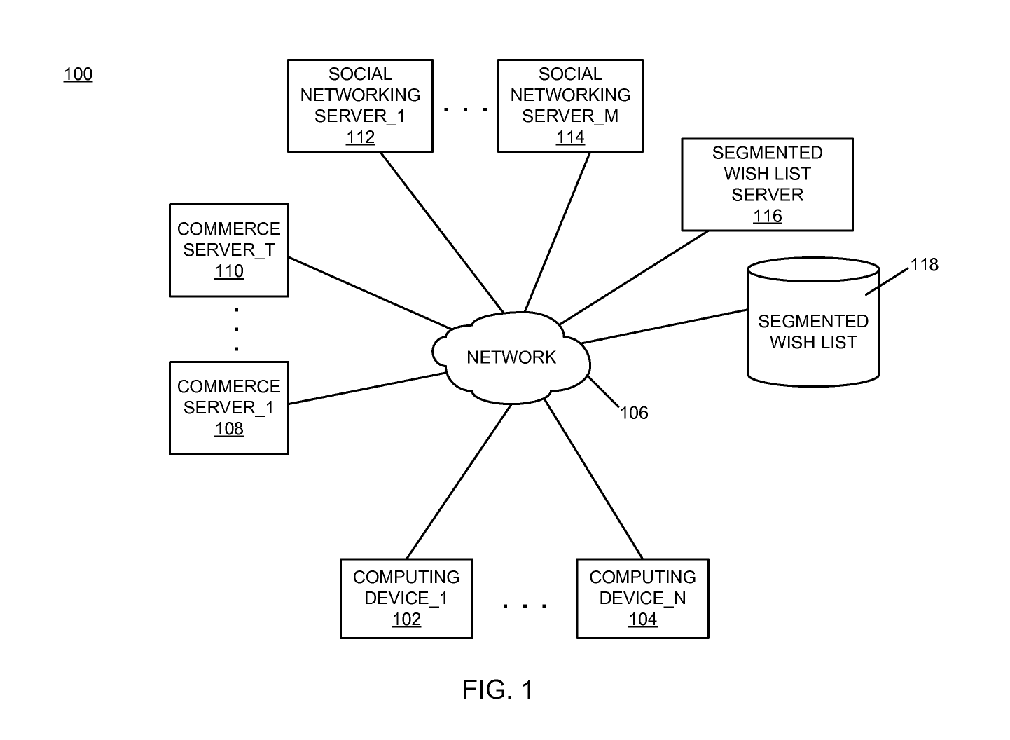

FIG. 1 is a block diagram of an example of an implementation of a system 100 for automated social group-based wish lists. A computing device_{—}1 102 through a computing device_N 104 communicate via a network 106 with several other devices. The other devices include a commerce server_{—}1 108 through a commerce server_T 110. The commerce server_{—}1 108 through the commerce server_T 110 may include retail commerce servers, wholesale commerce servers, or other forms of commerce servers as appropriate for a given implementation. The computing device_{—}1 102 through the computing device_N 104 may also communicate with a social networking server_{—}1 112 through a social networking server_M 114 that allow users of the computing device_{—}1 102 through the computing device_N 104 to interact for social networking purposes.

A segmented wish list server 116 processes social networking segmentation information (e.g., metadata) assigned by users of the computing device_{—}1 102 through the computing device_N 104 within the social networks established via the social networking server_{—}1 112 through the social networking server_M 114. The segmented wish list server 116 may generate, distribute, and update segmented wish lists.

The segmented wish list server 116 may store the segmented wish lists for distribution within a segmented wish list database 118. The segmented wish list database 118 may be accessed by the respective devices within FIG. 1 to perform the various processing tasks associated with the present subject matter.

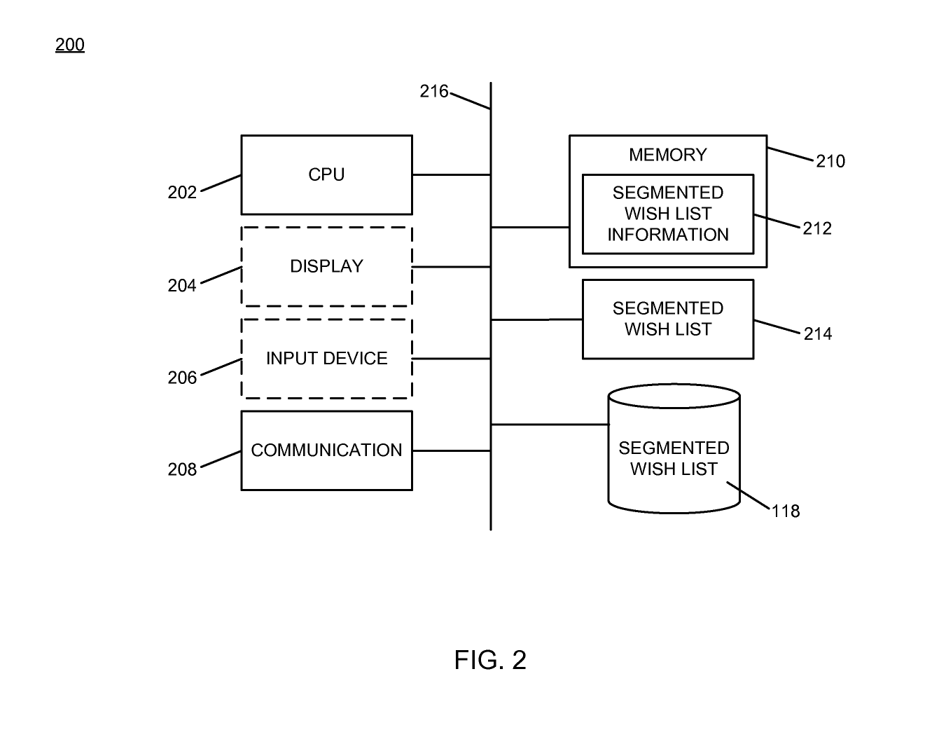

As will be described in more detail below in association with FIG. 2 through FIG. 5, the segmented wish list server 116 provides automated social group-based wish lists. The computing device_{—}1 102 through the computing device_N 104, the commerce server_{—}1 108 through the commerce server_T 110, and the social networking server_{—}1 112 through the social networking server_M 114 may each be configured to interact with the segmented wish list server 116 to perform push and/or pull operations of product offerings/information between the respective devices as described above. Alternatively, the respective commerce server_{—}1 108 through the commerce server_T 110 and the social networking server_{—}1 112 through the social networking server_M 114 may be configured to perform the push and/or pull operations of product offerings/information between the respective devices without interaction with the segmented wish list server 116, as appropriate for a given implementation. As such, a variety of possibilities exist for implementation of the present subject matter, and all such possibilities are considered within the scope of the present subject matter.

It should be noted that any of the respective computing devices described in association with FIG. 1 may be a portable computing device, either by a user's ability to move the respective computing device to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, music recording or playback device, etc.), or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of a core processing module 200 capable of performing automated social group-based wish lists. The core processing module 200 may be associated with the segmented wish list server 116 for creation and processing of segmented wish lists within social networks. Alternatively, the core processing module 200 may be associated with the computing device_{—}1 102 through the computing device_N 104, the commerce server_{—}1 108 through the commerce server_M 110, and the social networking server_{—}1 112 through the social networking server_M 114, as appropriate for a given implementation of the present technology. As such, the core processing module 200 is described generally herein, though it is understood that many variations on implementation of the components within the core processing module 200 are possible and all such variations are within the scope of the present subject matter.

Further, the core processing module 200 may provide different and complementary processing of social group-based wish lists in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, or any other type of input device by which the user may interact with and respond to information on the display 204.

It should be noted that the display 204 and the input device 206 are illustrated with a dashed-line representation within FIG. 2 to indicate that they may be optional components for the core processing module 200 for certain implementations/devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide the interconnection capabilities.

A memory 210 includes a segmented wish list information storage area 212. The segmented wish list information storage area 212 stores social networking segmentation information (e.g., metadata) useable to create and update segmented wish lists. The segmented wish list information storage area 212 may also store access control information useable to regulate visibility of segmented wish lists, and to configure and manage push/pull operations between the respective servers, as described above and in more detail below.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A segmented wish list module 214 is also illustrated. The segmented wish list module 214 provides analytical processing of segmented social network information and segmented wish lists for the core processing module 200, as described above and in more detail below. The segmented wish list module 214 implements the automated social group-based wish lists of the core processing module 200.

It should also be noted that the segmented wish list module 214 may form a portion of other circuitry described without departure from the scope of the present subject matter. Further, the segmented wish list module 214 may alternatively be implemented as an application stored within the memory 210. In such an implementation, the segmented wish list module 214 may include instructions executed by the CPU 202 for performing the functionality described herein. The CPU 202 may execute these instructions to provide the processing capabilities described above and in more detail below for the core processing module 200. The segmented wish list module 214 and/or any of its components may form a portion of an interrupt service routine (ISR), a portion of an operating system, a portion of a browser application, or a portion of a separate application without departure from the scope of the present subject matter.

The segmented wish list database 118 is also shown associated with the core processing module 200 within FIG. 2 to show that the segmented wish list database 118 may be coupled to the core processing module 200 without requiring external connectivity, such as via the network 106.

The CPU 202, the display 204, the input device 206, the communication module 208, the memory 210, the segmented wish list module 214, and the segmented wish list database 118 are interconnected via an interconnection 216. The interconnection 216 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale (POS) device, kiosk, or other location, while the CPU 202 and memory 210 may be located at a local or remote server. Many other possible arrangements for components of the core processing module 200 are possible and all are considered within the scope of the present subject matter. It should also be understood that, though the segmented wish list database 118 is shown as a separate module/component, the information stored within the segmented wish list database 118 may also be stored within the memory 210 without departure from the scope of the present subject matter. Accordingly, the core processing module 200 may take many forms and may be associated with many platforms.

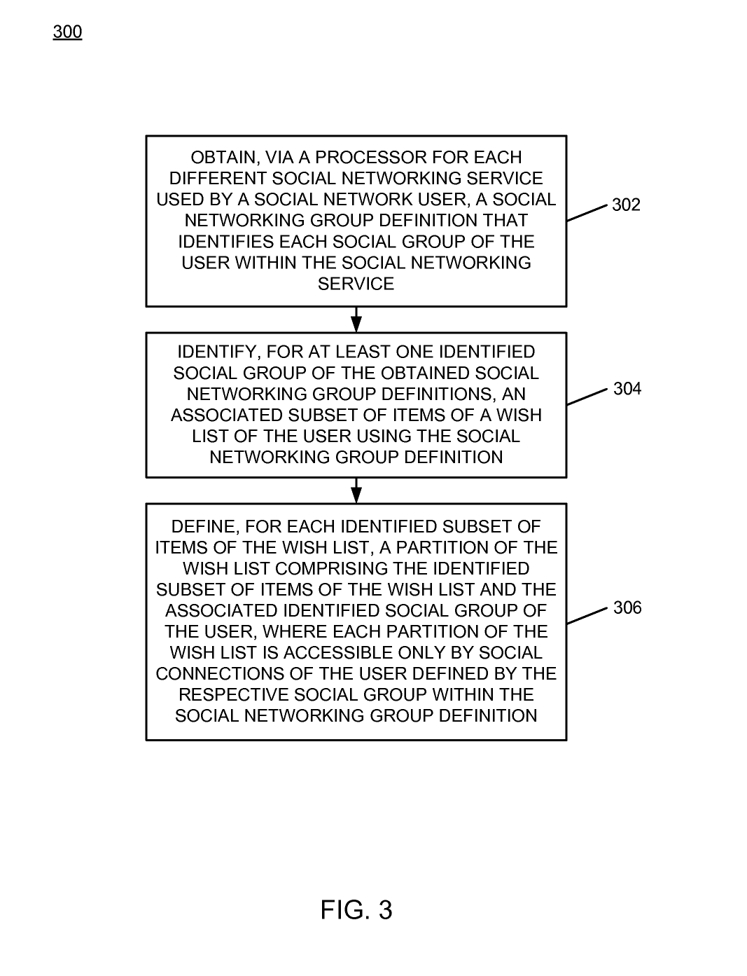

FIG. 3 through FIG. 5 described below represent example processes that may be executed by devices, such as the core processing module 200, to perform the automated social group-based wish lists associated with the present subject matter. Many other variations on the example processes are possible and all are considered within the scope of the present subject matter. The example processes may be performed by modules, such as the segmented wish list module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for automated social group-based wish lists. At block 302, the process 300 obtains, via a processor for each different social networking service used by a social network user, a social networking group definition that identifies each social group of the user within the social networking service. At block 304, the process 300 identifies, for at least one identified social group of the obtained social networking group definitions, an associated subset of items of a wish list of the user using the social networking group definition. At block 306, the process 300 defines, for each identified subset of items of the wish list, a partition of the wish list comprising the identified subset of items of the wish list and the associated identified social group of the user, where each partition of the wish list is accessible only by social connections of the user defined by the respective social group within the social networking group definition.

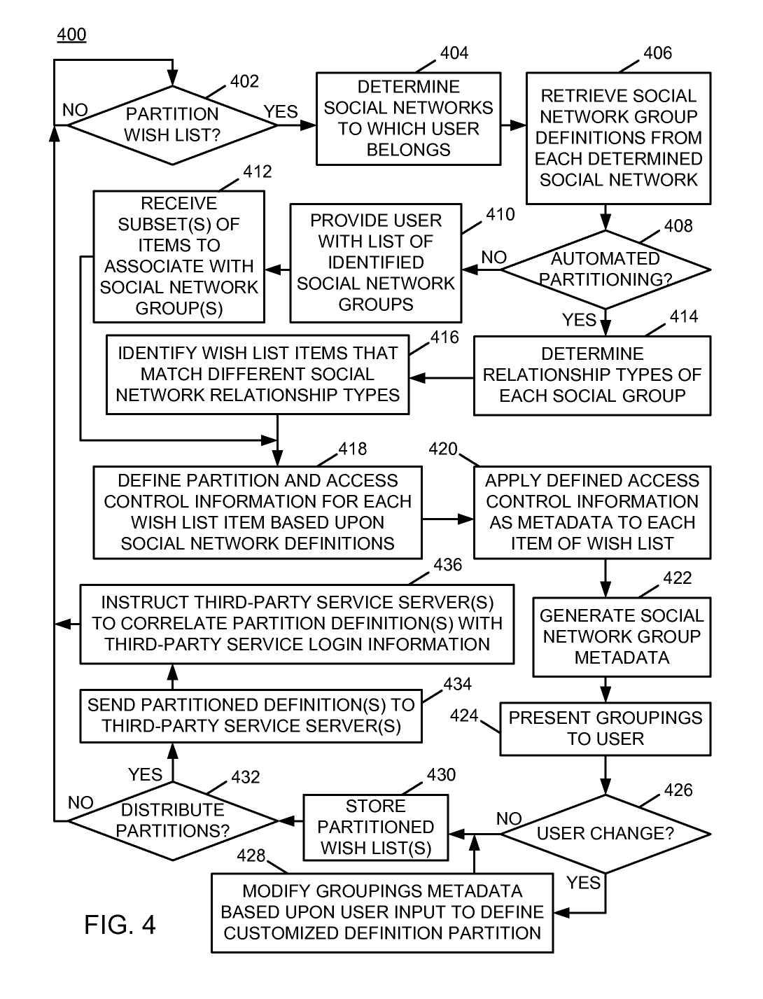

FIG. 4 is a flow chart of an example of an implementation of a process 400 for automated partitioning of social group-based wish lists. At decision point 402, the process 400 makes a determination as to whether a request from a user to partition a wish list has been detected. In response to determining that a request from a user to partition a wish list has been detected, the process 400 determines the social networks to which the user belongs at block 404. The process 400 may communicate with any accessible social networking services using an application programming interface (API) associated with each accessible social network service. The process 400 may determine, via the API associated with each accessible social networking service, whether the user has an account with the social networking service.

At block 406, process 400 retrieves social network group definitions from each determined social network. The process 400 may retrieve a social networking group definition that identifies each social group of the user within the social networking service from each determined social network via the API of the social networking service with which the user is determined to have an account.

At decision point 408, the process 400 makes determination as to whether to perform automated partitioning of the wish list based on the retrieved social network group definitions or whether the user is to identify the respective partitions of the wish list. In response to determining not to perform automated partitioning (e.g., that the user is to identify the respective partitions of the wish list), the process 400 provides the user with a list of the social groups identified within each obtained social networking group definition at block 410. At block 412, the process 400 receives from the user one or more subsets of items of the wish list that are associated with any identified social group(s) within any of the obtained social networking group definitions for which the user wishes to create a partition of the wish list. Additional processing for the identified subset(s) of items received from the user will be deferred and described in more detail below.

Returning to the description of decision point 408, in response to determining to perform automated partitioning of the wish list based on the retrieved social network group definitions, the process 400 determines relationship types of each social group within the retrieved social network group definitions at block 414. For example, social group types may include family groups, work groups, hobby groups, or other types of social groups.

At block 416, the process 400 identifies wish list items that match different determined social network group relationship types. The wish list items that match the different determined social network group relationship types may be inferred from context within a name of a social group and from context within product names or titles of items within the wish list. As such, the process 400 may programmatically interpret and infer relationships between wish list items and social groups based upon the names of those items and groups. The process 400 may further use the obtained social networking group definitions to identify an associated subset of items of the wish list of the user for each social group using the social networking group definition and the determined relationship types. For example, the obtained social networking group definitions may be configured to include context relationship metadata that identifies product types, categories, names, or other identifiers usable to determine whether wish list items match social networking group definitions.

In response to identifying the wish list items that match the different determined social network group types as part of the automated wish list partitioning at block 416, or in response to receiving from the user one or more subsets of items of the wish list that are associated with any identified social group(s) at block 412, the process 400 defines, for each identified subset of items of the wish list, a partition of the wish list and access control metadata for each wish list item in each partition at block 418. The access control metadata associated with wish list items in each defined partition identifies the social group associated with the defined partition.

At block 420, the defined access control metadata is applied to each item of the wish list that is within a defined partition. For example, the defined access control metadata may be added to each wish list item within the wish list, or partition metadata may be created for each partition that identifies the respective subset of items in the respective partition and the access control metadata may be added as part of the partition metadata, as appropriate for a given implementation.

At block 422, the process 400 generates social network group metadata that correlates the defined partitioning of the wish list with the respective social groups. At block 424, the process 400 presents the generated groupings to the user.

At decision point 426, the process 400 makes a determination as to whether a user change to the generated social network groupings and/or wish list partitions has been detected. As such, the process 400 may detect a request from the user to change the generated social network groupings and/or wish list partitions. Further, the process 400 may detect a request from a user to create a customized partition of the wish list including selected items of the wish list and/or identifiers of social connections from different social groups. For example, the user may request to aggregate different social groups and the associated wish list partitions, concatenate multiple social groups and wish list partitions, or otherwise modify or change and edit wish list partitions. Additionally, the user may enter a request to form custom social groups for wish list propagation using individual social connections from different social groups. Many other editing possibilities exist for wish list partitions and all such possibilities are considered within the scope of the present subject matter.

In response to detecting a request for a user change to the generated social network groupings and/or wish list partitions at decision point 426, the process 400 modifies the social network groupings metadata based upon user input to define the customized partition of the wish list including the selected items of the wish list and/or the identifiers of the social connections from the different social groups at block 428. In response to completion of the modification of the social network groupings metadata at block 428, or in response to determining that no user change has been detected at decision point 426, the process 400 stores the partitioned wish list(s) including the associated set(s) of metadata at block 430.

At decision point 432, the process 400 makes a determination as to whether to distribute the wish list partitions to one or more third-party services. In response to determining not to distribute the wish list partitions one or more third-party services, the process 400 returns to decision point 402 and iterates as described above. In response to determining to distribute the wish list partitions one or more third-party services, the process 400 sends any partition definition(s) of the wish list to be distributed to a third-party service server at block 434. As described above, the partition definitions include the identified subset of items of the wish list and the associated identified social group of the user.

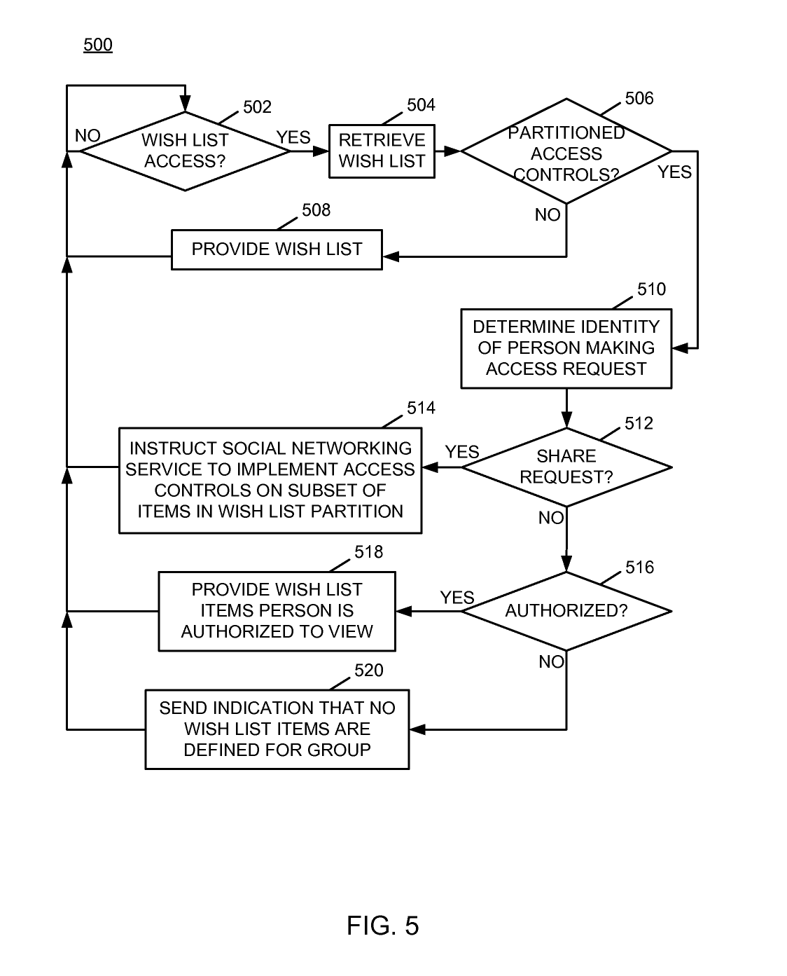

At block 436, the process 400 instructs the third-party service server to correlate the partition definition with third-party service login information to provide access to the identified subset of items within the defined partition of the wish list by social group connections within the associated identified social group of the user that log in to the third-party service server. As such, the partition definitions allow the third-party service server to regulate access to wish list items within each defined partition of the wish list based upon the defined partition, as described in more detail below in association with FIG. 5. The process 400 returns to decision point 402 and iterates as described above.

As such, the process 400 may perform automated partitioning of the wish list based upon obtained social network group definitions and may allow a user a high degree of editing ability for wish list partitioning. The process 400 defines access control information for wish list items based upon wish list partitions and may allow a user to create custom social groups that do not exist on the user's social networks by selectively adding social connections to form a new custom social group. A custom wish list partition may be associated with a custom social group to allow the user to apply granular access controls to wish list items. The process 400 may further distribute partitions to third-party services for correlation with login activities by the user's social connections on those third-party services.

FIG. 5 is a flow chart of an example of an implementation of a process 500 for automated access controls processing of social group-based wish lists. At decision point 502, the process 500 makes determination as to whether access to a wish list has been detected, such as via a social network or commerce website. In response to determining that access to a wish list has been detected, the process 500 retrieves the wish list at block 504.

At decision point 506, the process 500 makes a determination as to whether partitioned access controls have been configured for the wish list. As described above, where wish lists have been partitioned, individual items on the wish list may be partitioned into subsets and these subsets may be associated with different (e.g., one or more) social groups of a user. In response to determining at decision point 506 that partitioned access controls have not been configured for the wish list, the process 500 provides the entire wish list in response to the wish list access at block 508. The process 500 returns to decision point 502 and iterates as described above.

Returning to the description of decision point 506, in response to determining that partitioned access controls have been configured for the wish list, the process 500 begins processing to regulate access to wish list items within each defined partition of the wish list based upon the defined partition(s) and partitioning that is been configured for the wish list. At block 510, the process 500 determines the identity of the person making the access request. For example, the process 500 may determine that the person making the access request is the user associate with (e.g., owner of) the partitioned wish list itself. Alternatively, the process 500 may determine that the person making the access request is another person wanting to view the items on the wish list.

At decision point 512, the process 500 makes a determination as to whether the identified person making the access request is the user and whether the detected wish list access is a share request from the user to share a defined partition of the wish list, such as performed in association with social networking on a social networking website. For purposes of the present example, it is assumed that the share request is directed to a social group hosted by the social networking website and that a particular partition of the wish list is specified by the user to be shared.

In response to determining at decision point 512 that the identified person making the access request is the user and that the detected wish list access is a share request from the user to share a defined partition of the wish list, the process 500 instructs the social networking service to implement access controls as defined by the wish list partitioned metadata on the subset of items in the selected wish list partition at block 514. As such, the process 500 may instruct the social networking service that hosts the identified social group associated with the defined partition to implement access controls on the subset of items of the wish list based upon the associated identified social group within the social networking group definition used to identify the associated subset of items. The process 500 returns to decision point 502 and iterates as described above.

Returning to the description of decision point 512, in response to determining that the identified person making the access request is not the user and/or that the detected wish list access is not a share request from the user to share a defined partition of the wish list, the process 500 makes a determination at decision point 516 as to whether the identified person making the access request is authorized to access any items on the wish list associated with any wish list partition.

In response to determining at decision point 516 that the identified person making the access request is authorized to access items on the wish list associated with any wish list partition, the process 500 provides the wish list items the identified person that is authorized to view at block 518. In response to determining at decision point 516 that the identified person making the access request is not authorized to access items on the wish list associated with any wish list partition, the process 500 sends an indication that no wish list items are defined for the particular social group at block 520. By sending the indication that no wish list items are defined for the particular social group, the process 500 avoids sending an error notification or other notification that the person is unauthorized to access items within partitions of the wish list. In response to either providing the wish list items the identified person that is authorized to view at block 518 or sending the indication that no wish list items are defined for the particular social group at block 520, the process 500 returns to decision point 502 and iterates as described above.

As such, the process 500 regulates access to wish list items within each defined partition of the wish list based upon the defined partition(s). The process 500 may coordinate with social networking services to implement access controls on particular items within partitions of the wish list. Further, the process 500 assists with direct wish list access requests from social connections within social groups associated with the user.

As described above in association with FIG. 1 through FIG. 5, the example systems and processes provide social group-based wish lists. Many other variations and additional activities associated with social group-based wish lists are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
obtaining, via a processor for each different social networking service used by a social network user, a social networking group definition that identifies each social group of the user within the social networking service;
identifying, for at least one identified social group of the obtained social networking group definitions, an associated subset of items of a wish list of the user using the social networking group definition; and
defining, for each identified subset of items of the wish list, a partition of the wish list comprising the identified subset of items of the wish list and the associated identified social group of the user, where each partition of the wish list is accessible only by social connections of the user defined by the respective social group within the social networking group definition.

2. The method of claim 1, where obtaining, via the processor for each different social networking service used by the social network user, the social networking group definition that identifies each social group of the user within the social networking service, comprises:
communicating with a plurality of accessible social networking services using an application programming interface (API) associated with each of the plurality of accessible social networking services;
determining, via the API associated with each of the plurality of accessible social networking services, whether the user has an account with the social networking service; and
retrieving, via the API for each social networking service with which the user is determined to have the account, the social networking group definition that identifies each social group of the user within the social networking service.

3. The method of claim 1, where identifying, for the at least one identified social group of the obtained social networking group definitions, the associated subset of items of the wish list of the user using the social networking group definition comprises:
providing the user with a list of each social group identified within each obtained social networking group definition; and
receiving from the user the subset of items of the wish list that are associated with at least one social group identified within at least one of the obtained social networking group definitions.

4. The method of claim 1, where defining, for each identified subset of items of the wish list, the partition of the wish list comprising the identified subset of items of the wish list comprises adding access control metadata to each wish list item in each partition that identifies the social group associated with the defined partition.

5. The method of claim 1, further comprising regulating access to subset of items of the wish list within each defined partition of the wish list based upon the defined partition.

6. The method of claim 1, further comprising:
sending a partition definition for at least one defined partition of the wish list that comprises the identified subset of items of the wish list and the associated identified social group of the user to a third-party service server; and
instructing the third-party service server to correlate the partition definition with third-party service login information to provide access to the identified subset of items of the wish list within the defined partition of the wish list by the social connections within the associated identified social group of the user that log in to the third-party service server.

7. The method of claim 1, further comprising:
detecting a request from the user to share the defined partition of the wish list; and
instructing the social networking service that hosts the identified social group of the user associated with the defined partition of the wish list to implement access controls on the subset of items of the wish list based upon the associated identified social group within the social networking group definition used to identify the associated subset of items of the wish list.

8. The method of claim 1, further comprising:
detecting a request from the user to create a customized partition of the wish list comprising selected items of the wish list and identifiers of social connections from different social groups; and
defining the customized partition of the wish list comprising the selected items of the wish list and the identifiers of the social connections from the different social groups.

9. A system, comprising:
a memory that stores a wish list; and
a processor programmed to:
obtain, for each different social networking service used by a social network user, a social networking group definition that identifies each social group of the user within the social networking service;
identify, for at least one identified social group of the obtained social networking group definitions, an associated subset of items of the wish list of the user using the social networking group definition; and
define, for each identified subset of items of the wish list, a partition of the wish list comprising the identified subset of items of the wish list and the associated identified social group of the user, where each partition of the wish list is accessible only by social connections of the user defined by the respective social group within the social networking group definition.

10. The system of claim 9, where, in being programmed to obtain, for each different social networking service used by the social network user, the social networking group definition that identifies each social group of the user within the social networking service, the processor is programmed to:
communicate with a plurality of accessible social networking services using an application programming interface (API) associated with each of the plurality of accessible social networking services;
determine, via the API associated with each of the plurality of accessible social networking services, whether the user has an account with the social networking service; and
retrieve, via the API for each social networking service with which the user is determined to have the account, the social networking group definition that identifies each social group of the user within the social networking service.

11. The system of claim 9, where, in being programmed to identify, for the at least one identified social group of the obtained social networking group definitions, the associated subset of items of the wish list of the user using the social networking group definition, the processor is programmed to:
provide the user with a list of each social group identified within each obtained social networking group definition; and
receive from the user the subset of items of the wish list that are associated with at least one social group identified within at least one of the obtained social networking group definitions.

12. The system of claim 9, where, in being programmed to define, for each identified subset of items of the wish list, the partition of the wish list comprising the identified subset of items of the wish list, the processor is programmed to add access control metadata to each wish list item in each partition that identifies the social group associated with the defined partition.

13. The system of claim 9, where the processor is further programmed to regulate access to subset of items of the wish list within each defined partition of the wish list based upon the defined partition.

14. The system of claim 9, where the processor is further programmed to:
send a partition definition for at least one defined partition of the wish list that comprises the identified subset of items of the wish list and the associated identified social group of the user to a third-party service server; and
instruct the third-party service server to correlate the partition definition with third-party service login information to provide access to the identified subset of items of the wish list within the defined partition of the wish list by the social connections within the associated identified social group of the user that log in to the third-party service server.

15. The system of claim 9, where the processor is further programmed to:
detect a request from the user to share the defined partition of the wish list; and
instruct the social networking service that hosts the identified social group of the user associated with the defined partition of the wish list to implement access controls on the subset of items of the wish list based upon the associated identified social group within the social networking group definition used to identify the associated subset of items of the wish list.

16. The system of claim 9, where the processor is further programmed to:
detect a request from the user to create a customized partition of the wish list comprising selected items of the wish list and identifiers of social connections from different social groups; and
define the customized partition of the wish list comprising the selected items of the wish list and the identifiers of the social connections from the different social groups.

17. A computer program product comprising a computer readable storage medium including computer readable program code, where the computer readable program code when executed on a computer causes the computer to:
obtain, for each different social networking service used by a social network user, a social networking group definition that identifies each social group of the user within the social networking service;
identify, for at least one identified social group of the obtained social networking group definitions, an associated subset of items of a wish list of the user using the social networking group definition; and
define, for each identified subset of items of the wish list, a partition of the wish list comprising the identified subset of items of the wish list and the associated identified social group of the user, where each partition of the wish list is accessible only by social connections of the user defined by the respective social group within the social networking group definition.

18. The computer program product of claim 17, where, in causing the computer to obtain, for each different social networking service used by the social network user, the social networking group definition that identifies each social group of the user within the social networking service, the computer readable program code when executed on the computer causes the computer to:
communicate with a plurality of accessible social networking services using an application programming interface (API) associated with each of the plurality of accessible social networking services;
determine, via the API associated with each of the plurality of accessible social networking services, whether the user has an account with the social networking service; and
retrieve, via the API for each social networking service with which the user is determined to have the account, the social networking group definition that identifies each social group of the user within the social networking service.

19. The computer program product of claim 17, where, in causing the computer to identify, for the at least one identified social group of the obtained social networking group definitions, the associated subset of items of the wish list of the user using the social networking group definition, the computer readable program code when executed on the computer causes the computer to:
provide the user with a list of each social group identified within each obtained social networking group definition; and
receive from the user the subset of items of the wish list that are associated with at least one social group identified within at least one of the obtained social networking group definitions.

20. The computer program product of claim 17, where, in causing the computer to define, for each identified subset of items of the wish list, the partition of the wish list comprising the identified subset of items of the wish list, the computer readable program code when executed on the computer causes the computer to add access control metadata to each wish list item in each partition that identifies the social group associated with the defined partition.

21. The computer program product of claim 17, where the computer readable program code when executed on the computer further causes the computer to regulate access to subset of items of the wish list within each defined partition of the wish list based upon the defined partition.

22. The computer program product of claim 17, where the computer readable program code when executed on the computer further causes the computer to:
send a partition definition for at least one defined partition of the wish list that comprises the identified subset of items of the wish list and the associated identified social group of the user to a third-party service server; and
instruct the third-party service server to correlate the partition definition with third-party service login information to provide access to the identified subset of items of the wish list within the defined partition of the wish list by the social connections within the associated identified social group of the user that log in to the third-party service server.

23. The computer program product of claim 17, where the computer readable program code when executed on the computer further causes the computer to:
detect a request from the user to share the defined partition of the wish list; and
instruct the social networking service that hosts the identified social group of the user associated with the defined partition of the wish list to implement access controls on the subset of items of the wish list based upon the associated identified social group within the social networking group definition used to identify the associated subset of items of the wish list.

24. The computer program product of claim 17, where the computer readable program code when executed on the computer further causes the computer to:
detect a request from the user to create a customized partition of the wish list comprising selected items of the wish list and identifiers of social connections from different social groups; and
define the customized partition of the wish list comprising the selected items of the wish list and the identifiers of the social connections from the different social groups.
